(19) United States
(12) Patent Application Publication
(10) Pub. No.: US 2020/0378128 A1
(43) Pub. Date: Dec. 3, 2020

(54) VINYL AND MESH GUTTER COVER

(71) Applicant: Anthony M. Iannelli, Cincinnati, OH (US)

(72) Inventor: Anthony M. Iannelli, Cincinnati, OH (US)

(21) Appl. No.: 16/887,425

(22) Filed: May 29, 2020

Related U.S. Application Data
(60) Provisional application No. 62/854,646, filed on May 30, 2019.

(51) Int. Cl. E04D 13/076; B01D 39/12

(52) U.S. Cl. CPC E04D 13/076; B01D 39/12

(57) ABSTRACT

A gutter cover comprises a vinyl cover and a mesh screen. The vinyl cover is configured to extend longitudinally in overlaying relation to a length of gutter. It comprises a front edge and a rear edge. On the top of the vinyl cover adjacent to the front edge is a first slot which opens towards the rear edge, and between the front and rear edges is a second slot which opens towards the front edge. The mesh screen is metal and configured to extend longitudinally in overlayer relation to a length of gutter. It is wider than the distance between the first and second slots so that when it is installed into the first and second slots it bows upwardly from the top of the vinyl cover.

### CROSS REFERENCE TO RELATED APPLICATIONS

The present application hereby claims the benefit of the provisional patent application of the same title, Ser. No. 62/854,646, filed on May 30, 2019, the disclosure of which is herein incorporated by reference in its entirety.

### BACKGROUND

Homeowners can periodically clean out their gutters by climbing atop the roof or standing on a ladder. As an alternative, products have been created to prevent leaves and other debris from entering the rain gutters, such as gutter covers. These allow water to flow into the gutter but prevent leaves and other debris from doing so by various methods. Some gutter covers use a mesh screen to prevent the leaves and other debris from entering the gutter. However, when the mesh screens are damaged they end up collecting debris which reduces the effectiveness of the gutter cover and potentially creating other problems.

### BRIEF SUMMARY

A gutter cover comprises a vinyl cover and a mesh screen. The vinyl cover is configured to extend longitudinally in overlaying relation to a length of gutter. It comprises a front edge and a rear edge. On the top of the vinyl cover adjacent to the front edge is a first slot which opens towards the rear edge, and between the front and rear edges is a second slot which opens towards the front edge. The mesh screen is metal and configured to extend longitudinally in overlaying relation to a length of gutter. It is wider than the distance between the first and second slots so that when it is installed into the first and second slots the mesh screen bows upwardly from the top of the vinyl cover. The vinyl cover comprises at least one stiffener, which is a ridge formed from the vinyl cover that extends the length of the vinyl cover. The vinyl cover comprises at least one flex surface area, which is a longitudinally extending area the length of the vinyl cover that can be easily bent.

These and other objects and advantages shall be made apparent from the accompanying drawings and the description thereof.

### BRIEF DESCRIPTION OF THE FIGURES

The accompanying drawings, which are incorporated in and constitute a part of this specification, illustrate embodiments, and together with the general description given above, and the detailed description of the embodiments given below, serve to explain the principles of the present disclosure.

FIG. 1 is a top perspective view of the vinyl and mesh gutter cover.

FIG. 2 is an exploded view of the vinyl and mesh gutter cover.

FIG. 3 is an end view of the vinyl and mesh gutter cover.

FIG. 4 is an end view of the mesh cover.

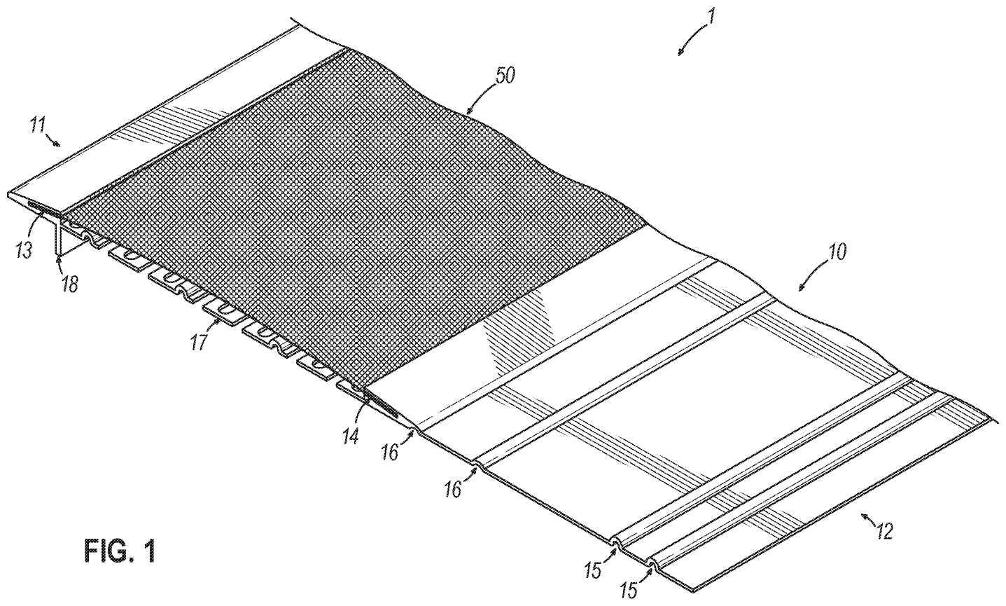

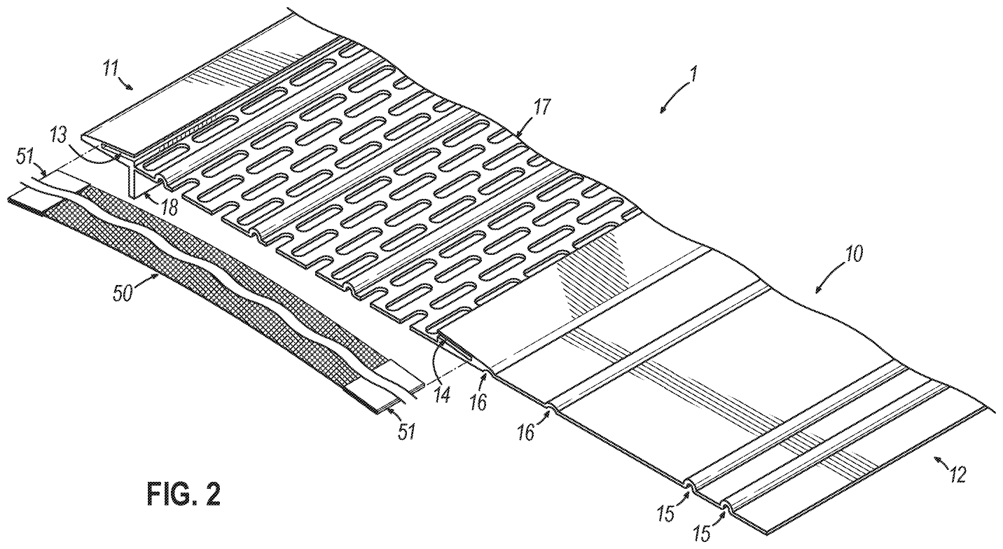

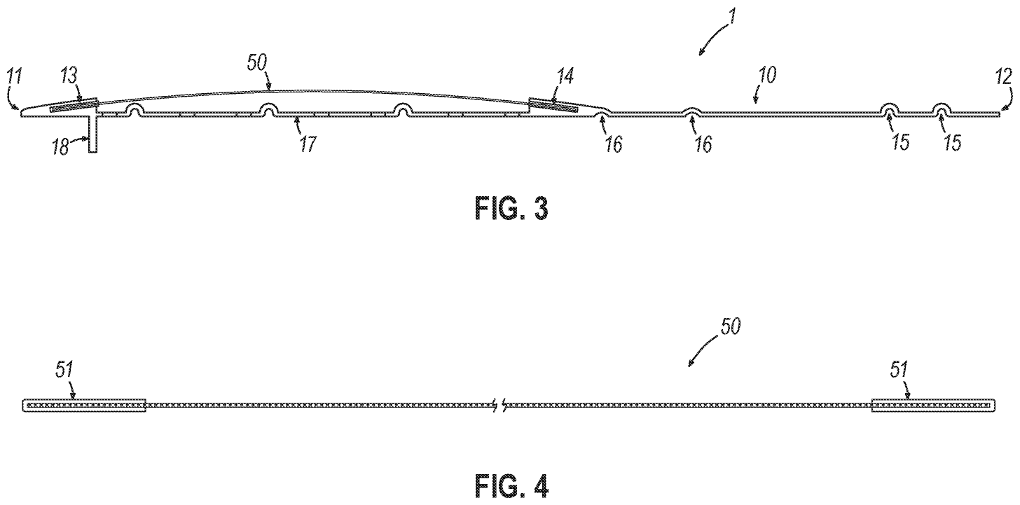

### DETAILED DESCRIPTION

A gutter cover (1) comprises a vinyl cover (10) and a mesh screen (50). The vinyl cover is configured to extend longitudinally in overlaying relation to a length of gutter. It comprises a front edge (11) and a rear edge (12). On the top of the vinyl cover adjacent to the front edge is a first slot (13) which opens towards the rear edge (12), and between the front (11) and rear edges (12) is a second slot (14) which opens towards the front edge (11). The mesh screen (50) is metal and configured to extend longitudinally in overlayer relation to a length of gutter. It is wider than the distance between the first (13) and second slots (14) so that when it is installed into the first and second slots the mesh screen bows upwardly from the top of the vinyl cover. The vinyl cover comprises at least one stiffener (15), which is a ridge formed from the vinyl cover that extends the length of the vinyl cover. The vinyl cover comprises at least one flex surface area (16), which is a longitudinally extending area the length of the vinyl cover that can be easily bent. The flex surface areas (16) are located so they may be bent to allow the gutter cover to fit either a 5 inch or 6 inch gutter.

In some embodiments, the vinyl cover comprises holes to allow water to flow into the gutter. Holes may be located on various locations of the vinyl cover, such as between the first and second slots, between the second slot and the rear edge, between the front edge and the first slot, or any combination thereof. In some embodiments, the holes are round, elongated circles, or a combination thereof.

The vinyl cover comprises a vinyl plastic. It may be made more rigid by the use of a stiffener, which is a ridge that runs the length of the vinyl cover. The ridge reduce the amount the vinyl cover flexes. In some embodiments, there are one or more stiffeners, such as two, three, and four stiffeners. The stiffeners may be between the second slot and the rear edge, between the first and second slots, between the front edge and the first slot, or any combination thereof.

The vinyl cover comprises at least one flex surface area. The flex surface area is a low, wide ridge, or thinner section, that allows the vinyl cover to bend along the flex surface area. In some embodiments, there are one or more flex surface areas, such as two, three, and four flex surface areas. The flex surface area may be between the second slot and the rear edge, between the first and second slots, between the front edge and the first slot, or any combination thereof. In some embodiments, a flex surface area is about 5″ from the front edge of the gutter cover. In some embodiments, a flex surface area is about 6″ from the front edge of the gutter cover. In some embodiments, there is a flex surface area about 5″ and one about 6″ from the front edge of the gutter cover. The flex surface area allows the gutter cover to be installed flat on a 5″ or 6″ gutter and to be bent upwards to fit underneath the shingles on the roof.

The vinyl cover comprises at least two slots that are angled toward each other to receive a mesh screen. On the top of the vinyl cover adjacent to the front edge is a first slot which opens towards the rear edge, on the top of the vinyl cover between the front and rear edges is a second slot which opens towards the front edge. In some embodiments, there are more than two slots, so there is more than one way to install the mesh screen.

The mesh screen (50) is a metal mesh screen that allows water to flow through it. The screen is flexible so that it may be bowed when installed into the slots on the vinyl cover. The mesh screen is wider than the distance between the two slots, so that it bows up when installed. In some embodiments, the mesh screen has smaller holes than the holes in the vinyl cover. This allows finer debris to be filtered from the rainwater before the water flows through the holes in the vinyl cover. In some embodiments, there are end covers (51) on the edges of the mesh screen. The end covers may be made from metal or plastic. They cover the potentially sharp edges of the mesh screen and can act to stiffen the screen to reduce flexing. If the mesh screen is damaged, it may be easily removed and replaced with a new screen.

In some embodiments, the vinyl cover comprises a lip descending at the front of the cover. The lip engages the inside of the gutter the cover is installed upon. It helps prevent the cover from sliding off the gutter.

While the present disclosure has illustrated by description several embodiments and while the illustrative embodiments have been described in considerable detail, it is not the intention of the applicant to restrict or in any way limit the scope of the appended claims to such detail. Additional advantages and modifications may readily appear to those skilled in the art. Furthermore, features from separate lists can be combined; and features from the examples can be generalized to the whole disclosure.

What is claimed is:

1. A gutter cover comprising a vinyl cover and a mesh screen;
wherein the vinyl cover is configured to extend longitudinally in overlaying relation to a length of gutter, the vinyl cover comprises a front edge and a rear edge, on the top of the vinyl cover adjacent to the front edge is a first slot which opens towards the rear edge, on the top of the vinyl cover between the front and rear edges is a second slot which opens towards the front edge;
wherein the mesh screen is metal and configured to extend longitudinally in overlaying relation to a length of gutter; the mesh screen is wider than the distance between the first and second slots so that when it is installed into the first and second slots the mesh screen bows upwardly from the top of the vinyl cover;
wherein the vinyl cover comprises at least one stiffener, which is a ridge formed from the vinyl cover that extends the length of the vinyl cover;
wherein the vinyl cover comprises at least one flex surface area, which is a longitudinally extending area the length of the vinyl cover that can be easily bent.

2. The gutter cover of claim 1, further comprising holes between the first and second slots.

3. The gutter cover of claim 2, wherein the holes are round.

4. The gutter cover of claim 2, wherein the holes are elongated circles

5. The gutter cover of claim 1, wherein end covers are on the edges of the mesh screen

6. The gutter cover of claim 1, further comprising a lip descending at the front of cover.

7. The gutter cover of claim 1, comprising a flex surface area about 5″ from the front edge

8. The gutter cover of claim 1, comprising a flex surface area about 6″ from the front edge

9. The gutter cover of claim 1, comprising a flex surface area about 5″ from the front edge and a second flex surface area about 5″ from the front edge.

10. The gutter cover of claim 1, comprising a stiffener between the two slots.

11. The gutter cover of claim 1, comprising a stiffener between the second slot and the back edge.
